(19) United States
(12) Patent Application Publication
(10) Pub. No.: US 2005/0075927 A1
(43) Pub. Date: Apr. 7, 2005

(54) Centrally controlled real-time purchase discounting system

(76) Inventor: Rodney Nash, Alameda, CA (US)

Correspondence Address: Rodney Nash, 311 Tideway Dr., 201, Alameda, CA, 94501, US

(21) Appl. No.: 10/600,005

(22) Filed: Jun. 20, 2003

Related U.S. Application Data
(60) Provisional application No. 60/390,678, filed on Jun. 21, 2002.

(51) Int. Cl. G06F 17/60

(52) U.S. Cl. 705/14; 705/16

(57) ABSTRACT

This invention is an innovative solution to antiquated paper coupons. It overcomes deficiencies of couponing systems by using electronic data systems to process a plurality of discount transactions in parallel with the consumers purchase via real-time discounting matrix. This consumer focused system comprises a business related process possessing the means of: transceiving consumer purchase data; managing databases related to discount available items, consumer purchase performance, history, preferences, transaction history, etc.; accessing discount matrix. Individual consumers use a variety of technologies to initiate the discounting transaction during the purchase process, to perform the real-time connection, to quarry, and to reporting on matrix transactions for discount authorizations simultaneously for a plurality of retail and Internet based point of sale locations. This discount process provides a means of better determining the consumer's intent to receive discounts on desired retail goods and services through a plurality of measured definitions in the purchase process.

### CROSS REFERENCE TO RELATED APPLICATIONS

This patent is derived from provisional patent #60/390,678 filed on Jun. 21, 2002. See attached Form 08B for Crossed referenced articles and publications.

### BACKGROUND OF INVENTION

It is a well-established practice for manufactures, vendors, wholesalers, and retailers to distribute coupons as a means of product marketing to attract consumers to their particular stores or products. Coupons can be taken to a redemption center, such as a retail store, and redeemed for some type of service, exchanged for currency or other value such as a discount toward a current or future purchase. Coupons do not equal discounts. Rather they functions as vouchers and advertisement for a specific purchase discount. Currently coupons are sent to a retail clearinghouse after they are redeemed during a purchase, which sorts and counts them & pays or reimburses the retailer. The clearinghouse is then tasked with getting reimbursed by the coupon issuer either a wholesaler or a retailer. This method of marketing or distributing purchase incentives has continued to be somewhat effective since popularization of coupons during the depression and their first use by Coca-Cola in 1894. Though the use of coupons remains high, above 80% of the population, the percentage of coupons actually redeemed, as a percentage of the total coupons issued is astonishingly low. It would appear that most of these users surveyed by the industry associations either don't use coupons regularly with every purchase or there aren't coupons regularly available for the particular items they frequently purchase. While well over 330 Billion coupons are distributed annually only about 4 Billion are redeemed, less than 2%, representing an estimated savings of over $4.7 Billion in recent years. Marketers spent a total of $6.3 Billion on design, production, distribution and redemption of coupons in 2000. According to the government and industry sources, the total value of the all distributed coupons is over $280 Billion. It is not reasonable to expect that all coupons could be redeemed; however a judgment of efficiency of use and therefore cost effectiveness would dictate higher redemption rates. The most highly distributed coupon categories are for household cleaners, condiments, frozen foods, medications, health aids and paper products. There is no public data showing that groups of coupons of the most highly redeemed coupons are the most desired of purchases of the vendors” desired demographic redeeming discount. Moreover, it would seem that a higher participation rate demonstrated through the higher redemption rate or use of coupons and the acquisition of discounts, not just the amount of individuals using them is highly desirable.

It is well known that while a discount is being offered to the purchaser, the primary goal of the vendor or retailer issuing the coupon is incentive based sale and advertisement. While the goal for the consumer is the discount and notification of where the items are on sale. Because of the pros and cons associated with the varied manner and methods of coupon distribution, the true statistical acceptance and effectiveness of specific coupons based on demographics is not known. The current mass-marketing process is inefficient and antiquated. Several conditions make the widespread use and acceptance of technology used in everyday life to create new tools, process, methods, and opportunities that form a more efficient distribution of discounts, not coupons; to deliver specific demographic requested services to more effectively market products by using technology to more efficiently “micro-market” and decrease marketing & distribution costs. For so long, vendors and consumers have perceived coupons and discounts, as equal and that one cannot exist without the other. This well-established practice however, has many disadvantages for the vendor, retailer and end user. For so long consumers and retailers have functioned like two ships passing in the night. One literally casting coupons over the wide ocean like confetti, hoping the coupons find their way to an interested consumer. While consumers sit adrift waiting like pilgrims for manna from heaven for what ever coupons comes drifting along.

Here-to-fore coupons have been distributed through a variety of method. These distribution methods have advantages and disadvantages of varying degrees, yet they all have one constant element the mass market or shotgun distribution pattern. Problems associated with some of these existing distribution processes include: Long lead times for coupon production, coupons that only reach the consumer after the purchase, Little to no demographic targeting or verification, unenforceable provisions of customer limits such as quantity and time, limited customer reach. Mass-marketing methods, including the internet based methods involve the (transfer of electronic images to paper) application of paper, coupons which lead to a situation were the consumer has to carry, store, and track a plurality of small pieces of paper of varied sizes.

As the use of technology has grown, various technological applications have employed various processes and devices to distribute coupons. Most required additional equipment to be used by the consumer (i.e. such as a computer with internet connectivity and a printer), most are limited in use to individual grocery store chains where items are readily displayed, all require the consumer to be knowledgeable and vigilant with regard to gathering, storing, tracking coupons, on going sales, as well as remembering, asking for and attaining a redemption of the coupon at the cashiers station. The traditional methods, previously mentioned are inherently flawed, primarily because of the lack of automation. To the contrary, all of these distribution methods involve, at some level, human involvement in these delivery processes. Discounted transactions represent a very small portion of all retail purchases according to US Dept. of Commerce and trade associations. Added to this weak use of coupons, are several issues or concerns facing the coupon industry such as coupon validation, audit, limited value codes and fraud controls according to recent survey of retailers. The current invention comprises a discount system providing a method and process which recognizes that the true goal of the consumer is the attainment the discount, not get lost in the process of finding and holding onto the coupon. The true goal of the retailer or vendor, in addition to effective advertising and increased sales is getting more specific information about their customers, to provide better products and services. The true goal of the retailer is to buy products that are very likely to be sold and to facilitate the purchase transaction with as much ease as possible without additional costs and inconvenience of providing the discount service to the customer.

The problems associated with using coupons to attain discounts are numerous. They include participating in a pre-purchase activity of some kind i.e., if the coupon is on the packaging of an item previously purchased or rear of the a retail purchase receipt, actions required by the consumer such as cutting or clipping, storing and tracking the paper coupons, and remembering to retrieve them for the next trip to the store if you remember to buy the specific item. Additionally, retail personnel have the added burden of the storage and inventory of a variety of coupons and the retrieval of re-imbursement fee from the vendor, at what is essentially an overhead cost to the retailer. Insofar as the original vendor of the product is concerned, while they receive direct evidence that consumers are using their coupons, and the number of coupons coming back to the original vendor indicates some small level of success in advertisement execution, there is very little additional marketing information that can be derived from this type of paper coupon distribution and redemption scheme. The original vendors or coupon originator receives no information about the individual consumer which would be of great value in planning future advertising programs, since coupons are submitted anonymously, and contain no information regarding the consumer or his/her purchasing habits or preferences and lifestyle. While some demographic information can be obtained by tracking the regional and geographic locations in which the coupons were redeemed, vendors continue to pay large amount of money on marketing surveys to get statistical data about past or potential customer when real-time purchasing data would be more useful and is attainable with the use of the process that is the subject of this patent.

The current method of coupon distribution involves a system that randomly distributes free coupons that are regularly used by less than 25% of the buying public. Effectively, vendors are canvassing by over saturating the market of perceived potential shoppers to get discount incentivised sales generation associated with less than 2% of the coupons issued. This is wholly inefficient because of the costs associate with managing, publishing and distribution of these discounts is a large part of most marketers budgets. This physical handling of coupons is expensive, cumbersome, wrought with errors and subject to manipulation by humans. Additional issues regarding waste, and fraud arise from an unscrupulous retailer, that requests reimbursement payments by presenting unredeemed coupons to the vendors clearinghouse. These are pasted on the coupon originator. The current system is not appreciated or successful as evidenced by the poor level of participation and low percentage sales volume associated with coupons. The overhead associated with design costs, insertion costs, redemption costs, managing and tracking pieces of paper burdens all the participants, from the users, retailers, to the vendors. While only providing the perceived benefit of increased sales for the retailer & vendor and for the consumer, discounts on items purchased because they were on sale not because they were desired. The notion that consumers will buy more of something that is truly desired.

When carefully analyzed, the many problems and pitfalls associated with existing paper based coupon redemption programs are numerous. A new and innovative solution that utilizes technology is needed to effectively modernize the coupon system and transform it to a more efficient point of sale discounting service that is truly beneficial to all the systems participants, a system and business process that is truly appreciated by all. The current system easily conforms to the changing global supply chain landscape. The present invention overcomes all the deficiencies and disadvantages associated with the current paper coupon redemption system by using existing technology in an innovative manner to process in real-time a plurality of purchase discounts, at the time of the consumers of purchases. The discounting system uses existing mechanisms such as PVC magnetic strip type ATM/Check Card, smartcards or other select identifier to initiate the discount transaction during the purchase process and provides method of connectivity to Discount Database via the POS machine, POS acquirer/merchant banking system or other proprietary electronic telecommunication connectivity. The system provides authentication, authorization, Purchase Inventory Data-PID such as User ID, UPC Data purchase location etc., and transfers to Discount Database via interface software and existing telecommunication infrastructure.

This invention comprises a discounting process relating to the following 5 major entities, accomplishing the following tasks: integrated electronic correspondence database (1. Discount Database) and electronic communications infrastructure which stores and allows query of a plurality of numerous vendors specific products and product information by consumer purchase inventory data discount requests electronically connected via existing public or proprietary electronic data links. The purchase discounting process allows consumers at point of purchase to receive instant in-store discounting of item/s currently being purchased. The consumers (2. Discount Requestor) can access the system at a plurality of POS locations or system interface points that honor any plurality of discount system ID devices and system initiation mechanisms and provide transmission of purchase inventory data and access to the Discount Database & service center via the retailer cashier station. The vendors (3. Discount Originator) use the discount system and participates in the process by providing information on items prescribed for discounts to the system via electronic data link access to the Vendor Discount Inventory database and providing reimbursement. The retailers (4. Discount Issuer) use the discount system and participates by honoring any plurality of system ID devices and provide electronic connection and transmission (5. Discount System Operator) of PID and authorized access to the Discount Database which includes the upload of PID to the Discount database for quarry, correspondence discount authorization The discount process also recognizes that the goal of the vendor is to attain higher sales volume than their competition. The discount process is the truest form of instantaneous or real-time purchase discounting. This discounting database process provides a plurality of means for monitoring and archiving consumer purchase histories, desires and preference. The discount process provides micro-marketing components that allow vendors to advertise directly to consumers based on specific items indicated and desired or previously purchased for vendors who desire to better address specific consumers desires by accessing discount databases and providing pre-approved or guaranteed discounts based on consumers preference also to develop a customer profile or market analysis for future product promotions that span a plurality of markets and products but for individual consumers.

Under this discount process there is minimal threat of abuse and fraud that exist with traditional paper coupons because discounts are applied directly to purchase and completed at the point of sale in real time or possibly retrieved by the consumer at some time in the future through the use of any ATM machine or to be applied to other purchases. There is no additional work for the retail representative or store clerk to perform at the end of their shift, as there are no coupons to redeem. The retailer simply performs a one-time modification of their purchase transaction software to allow for transmission an additional purchase data, specifically the consumers PID that contains standard bar code data and product identification numbers or UPC data and related item costs to the Discount Database and Service Center. Key elements of this Discount Method Process are: Discount Interface Software (not the subject of the patent), Method of retailer to establish communication session, interfaces with and transmits purchase information to database. Secure transmission of PID along with purchase price and other vital station ID information, using existing POS connectivity equipment.

Additionally, this patent covers a method of PID quarry and system authorization from the Discount Database and vendors input system. This telecommunication link or functionary is known as the back end software package. A method of establishing and operating functionary that provides ACH Authorization Interface. To provide a discount distribution and redemption system which can identify users of the system before they make coupon selections and offer different coupons to different users of the system before they make coupon selections on the basis of already—obtained demographic data about the users. Discount Fund A method of providing optional means wherein retailer redemption of coupon transactions from vendor to retailer is automatic. Once the automated and secure verification of the inventory of purchased items is achieved at the retailer location and the Discount Database authorizes the exact amount of discount credit that the retailer should extend to the customer. The system releases Discount Fund credits to the retailer merchant bank via EFT/ACH, as well as notification of this financial transaction. The Discount system operator then seeks reimbursement from the discount originator or because these discounts can be requested prior to purchase or pre-approved the Discount has deposits placed in them at earlier date by the vendors deposits.

### SUMMARY OF INVENTION

The present invention overcomes all the deficiencies and disadvantages associated with the current paper coupon redemption system by using existing technology in an innovative manner to process in real-time a plurality of purchase discounts, at the time of the consumers of purchases. The discounting system uses existing mechanisms such as PVC magnetic strip type ATM/Check Card, smartcards or other select identifier to initiate the discount transaction during the purchase process and provides method of connectivity to Discount Database via the POS machine, POS acquirer/merchant banking system or other proprietary electronic telecommunication connectivity. The system provides authentication, authorization, Purchase Inventory Data-PID such as User Identification, UPC Data purchase location etc., and transfers to Discount Database via interface software and existing telecommunication infrastructure.

This invention comprises a process relating to the following 5 major entities, accomplishing the following tasks: integrated electronic correspondence database (1.) “Discount Database” and electronic communications infrastructure which stores and allows query of a plurality of numerous vendors specific products and product information by consumer purchase inventory data discount requests electronically connected via existing public or proprietary electronic data links. The purchase discounting process allows consumers at point of purchase to receive instant in-store discounting of item/s currently being purchased. The consumers (2.) “Discount Requestor” can access the system at a plurality of POS locations or system interface points that honor any plurality of discount system ID devices (i.e. smartcard, magnetic card, etc.) and system initiation mechanisms. The Discount Requestor also utilizes a plurality of services provided by the “Discount System Operator” to automatically or manually seek and pursue a plurality of discounts and/or guarantees of discounts to be provided. The vendors (3.) “Discount Originator use the discount system and participates in the process by providing information on items prescribed for discounts to the system via electronic data link access to the Vendor Discount Inventory database and providing reimbursement. The retailers (4.) “Discount Issuer use the discount system and participates by recognizing or honoring any plurality of system ID devices and provide electronic connection and transmission (5.) “Discount System Operator” installs software at the retailer location that provides connectivity for reception for PID (Purchase Inventory Data) transmitted to and authorizes access to the “Discount Database” which includes the performs tasks such as database authentication, quarry, reporting, correspondence and discount authorization. The Discount System Operator also reimburses retailers for discounts issued and seeks reimbursement from vendors and wholesalers for discounts reimbursed.

The real-time discount system process involves a plurality of communications protocols to establish communication session, transmit “Discount Requestor”, “Discount Issuer”, & PID Data over a plurality of various communications medium such as ADSL, Cable, Satellite, Wireless, Phone Line Modem etc. The process includes a plurality of POS Machines located at a plurality of retailer locations, a plurality of consumers utilizing PVC magnetic strip type ATM/Check Card, smartcards or other select identification assets to initiate the discount cycle during the purchase process, a plurality of software programs (software and/or other intellectual property that is the subject of other patent/s) to provide control, interface, input/output and communication capability. The POS data link uses a typical protocol such as Telnet, TFTP, TCP/IP, Telnet, DHCP, PPPoE, SNMP, FTP, STMP, etc., to transmit a plurality of encrypted data via 10Base-T/100Base Network interface as well as dialup modem. This discount system is a process where in the following entities (“Discount Requestors, Discount Originators”, Discount Issuer, Discount System Operator, Discount Database, Discount Fund) manage, communicate, establish, send and receive and otherwise interact to provide the unique service of distributing purchase discounts in real-time.

In addition to improvements of this invention such as a method of generating, storing transmitting PID, authenticating, database quarry, report and authorizing, notification, significant innovations of utilizing this new real-time purchase discount system and method of providing discounts is the “Micro-Marketing Matrix” that provides “Micro-Marketing” knowledge base and opportunities to consumers (Discount Requestors) and micro advertising opportunities for vendors (Discount Originators) as well as the “Individualized Discount Request Matrix”. In the situation where vendor is also the retailer (Discount Issuer), the retailers discounting activities can be outsourced and both discount fund and reimbursement transactions can be eliminated thru the scope, scale, efficiency, use of technology to function as the backbone the Real-Time Purchase Discounting Process infrastructure.

### BRIEF DESCRIPTION OF DRAWINGS

### Centrally Controlled Real-Time Purchase Discounting System Diagram

This diagram demonstrate the major entities involved in the process of distributing discounts according to the method prescribed in this patent. The interrelations, hierarchy and communication process of these entities for the purpose of distributing discounts is the essence of this patent.

### DETAILED DESCRIPTION

This invention comprises a process relating to the following 5 major entities, accomplishing the following tasks: integrated electronic correspondence database (1.) “Discount Database” and electronic communications infrastructure which stores and allows query of a plurality of numerous vendors specific products and product information by consumer purchase inventory data discount requests electronically connected via existing public or proprietary electronic data links. The purchase discounting process allows consumers at point of purchase to receive instant in-store discounting of item/s currently being purchased. The consumers (2.) “Discount Requestor” can access the system at a plurality of POS locations or system interface points that honor any plurality of discount system ID devices (i.e. smartcard, magnetic card, etc.) and system initiation mechanisms. The Discount Requestor also utilizes a plurality of services provided by the “Discount System Operator” to automatically or manually seek and pursue a plurality of discounts and/or guarantees of discounts to be provided. The vendors (3.) “Discount Originator use the discount system and participates in the process by providing information on items prescribed for discounts to the system via electronic data link access to the Vendor Discount Inventory database and providing reimbursement. The retailers (4.) “Discount Issuer use the discount system and participates by recognizing or honoring any plurality of system ID devices and provide electronic connection and transmission (5.) “Discount System Operator” installs software at the retailer location that provides connectivity for reception for PID (Purchase Inventory Data) transmitted to and authorizes access to the “Discount Database” which includes the performs tasks such as database authentication, quarry, reporting, correspondence and discount authorization. The Discount System Operator also reimburses retailers for discounts issued and seeks reimbursement from vendors and wholesalers for discounts reimbursed.

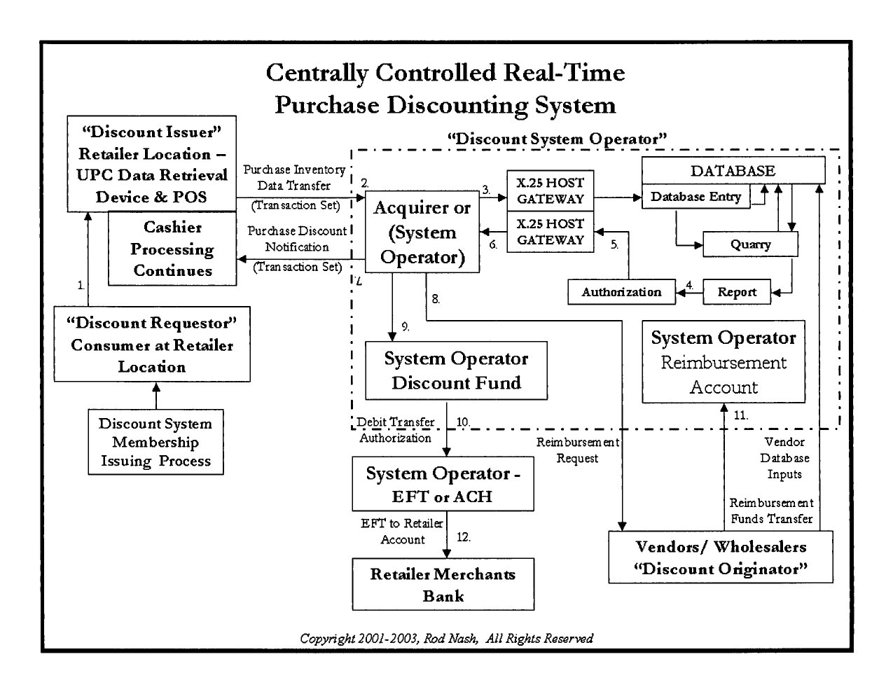

The Discounting system process cycle starts when a discount member or consumer (FIG. 1 #1.) swipes card at POS or other Discount System Identification Device for proprietary communication path. The UPC data, which is electronically collected at the retailer cashier station. The discount system software retrieves the UPC data, initiates a communication session via POS/merchant bank links, just as with any other credit card or smart card. The UPC data, once combined with the identification information of the discount member or consumer and the store locator ID information, it becomes Purchase Inventory Data (PID). This information is shipped in data packets conforming to EDI and ANSI X.25 standards. ACS X.12 transaction sets are used to accommodate transmission of this data to the (FIG. 1. #2.) Discount System Operator database location via acquirer computer & banks. The data is process depending of what communications protocol the retail locations POS machine uses. The (FIG. 1 #3) x.25 gateway holds session with the retail location to receive all PID information. This information is forms a database entry at that time. The database perform a plurality of predetermined functions at this time and generates a report (FIG. 1 #4.) which is the basis for the authorization and notification back thru the gateway (FIG. 1. #5.) back thru the Acquirer (FIG. 1 #6.) to the retailer location (FIG. 1 #7.). The retailer receives notification in real-time with a currency amount to be deducted or discounted from the full purchase price. The retailer and consumer can now continue with the trans as they see fit. The Discount System Operator (FIG. 1 #8.) requests reimbursement from the Vendor and authorizes the payment of the retailer (FIG. 1 #9.). The Funds are transferred EFT (FIG. 1 #10.) to the retails bank account (FIG. 1 #12). The (FIG. 1 #11.) vendors who have received notifications of sales and discount activity as well as reimbursement request. They send EFT, reimbursement fees to the System Operator.

The discount process also recognizes that the goal of the vendor is to attain higher sales volume than their competition. The discount process is the truest form of instantaneous or real-time purchase discounting. This discounting database process provides a plurality of means for monitoring and archiving consumer purchase histories, desires and preference. The discount process provides micro-marketing components that allow vendors to advertise directly to consumers based on specific items indicated and desired or previously purchased for vendors who desire to better address specific consumers desires by accessing discount databases and providing pre-approved or guaranteed discounts based on consumers preference also to develop a customer profile or market analysis for future product promotions that span a plurality of markets and products but for individual consumers.

Under this discount process there is minimal threat of abuse and fraud that exist with traditional paper coupons because discounts are applied directly to purchase and completed at the point of sale in real time or possibly retrieved by the consumer at some time in the future through the use of any ATM machine or to be applied to other purchases. There is no additional work for the retail representative or store clerk to perform at the end of their shift, as there are no coupons to redeem. The retailer simply performs a one-time modification of their purchase transaction software to allow for transmission an additional purchase data, specifically the consumers PID that contains standard bar code data and product identification numbers or UPC data and related item costs to the Discount Database and Service Center. Key elements of this Discount Method Process are: Discount Interface Software (not the subject of the patent), Method of retailer to establish communication session, interfaces with and transmits purchase information to database. Secure transmission of PID along with purchase price and other vital station ID information, using existing POS connectivity equipment.

Additionally, this patent covers a method of PID quarry and system authorization from the Discount Database and vendors input system. This telecommunication link or functionary is known as the back end software package. A method of establishing and operating functionary that provides ACH Authorization Interface. To provide a discount distribution and redemption system which can identify users of the system before they make coupon selections and offer different coupons to different users of the system before they make coupon selections on the basis of already—obtained demographic data about the users. Discount Fund is a method of providing optional means wherein retailer redemption of coupon transactions from vendor to retailer is automatic. Once the automated and secure verification of the inventory of purchased items is achieved at the retailer location and the Discount Database authorizes the exact amount of discount credit that the retailer should extend to the customer. The system releases Discount Fund credits to the retailer merchant bank via EFT/ACH, as well as notification of this financial transaction. The Discount system operator then seeks reimbursement from the discount originator or because these discounts can be requested prior to purchase or pre-approved the Discount has deposits placed in them at earlier date by the vendors deposits.

Once given the above disclosure, many features, modification, and improvements will become apparent to the skilled artisan. Such other features, modifications, and improvements are therefore considered to be a part of this invention, the scope of which is to be determined by the following claims.

1. A method of processing real-time purchasing discounts by the means of a method and process comprising:
issuing a plurality consumers or “Discount Requestors” affiliation or association with discount system & process along with system identification assets i.e., ANSI standard magnetic cards, magnetic card, smartcard, bio-metrics, etc;
issuing a plurality vendors or “Discount Originators” affiliation or association with discount system & process along with system access privileges to upload and download a plurality of product data to and from the “Discount Database”;
issuing a plurality of retailers or “Discount Issuers” affiliation or association with the discount system & process along with system access privileges to upload and download a plurality of product data to and from the “Discount Database”;
initiating a plurality of discount process cycles at retail location is started by means of use of a plurality consumers action with magnetic strip cards, smartcards swipe at, on or inserted into of a POS machine at a plurality of retail locations (i.e. grocery store, restaurant, gas station, convenience store, website, online, etc.,) to use of any plurality of POS devices that acknowledge a plurality of consumer identification devices, i.e., (ANSI standard magnetic cards, magnetic card, smartcard, bio-metrics, etc);
initiating a plurality discount process cycles at retailer website locations wherein consumer of “Discount Requestor” identification information is entered into data fields on retailer website, that is linked to the Discount System Operator; and
acquiring a plurality of UPC data with a collection of off the shelf UPC software located at retailer location—or linked to online retailers website from input devices attached to cashier station and establishing communication session with Discount Operator via a plurality merchant acquirers, banking system communication links to transmit Purchase Inventory Data-PID.

2. the method in claim 1, wherein a means of getting a plurality Purchase Inventory Data transmissions of PID to Discount Operator from a plurality of retailer locations.
Communications links to merchant bank or acquirer with communication data transmission existing equipment such as satellite, wireless, modem, ADSL, Cable etc., using data transfer protocols such as APACS, ISO8583, HGEPOS, TCP/IP via a ANSI X.12 data packet transfer standards:
transmitting a plurality of PID data packets containing Purchase Inventory Data to Discount Operator via communications path or merchant bank and acquirer to facilitate transmission with ACS X.12 transactional set protocol;
receiving a plurality of PID data packets in a variety of POS protocols such as APACS, ISO8583, HGEPOS, TCP/IP etc., via the ANSI X.25 gateway, PID data; and
validating a plurality of PID data received at Discount Operator Location and entering PID data into Discount Database.

3. the method in claim 1, wherein a means an off the shelf database software capable of performing a plurality of database tasks (i.e. update, automated data entry, receiving, transmitting, storage, organization, quarry, reporting, data verification, user authentication, data mining, demographic research, etc., of PID data;
processing a plurality of retailer PID Data and generating discount authorization & report; and
transmitting a plurality of discount authorizations back to point of sale location, website cashier, retail cashier station or any plurality of purchasing environments and situations.

4. the method in claim 1, wherein a collection of off the shelf UPC software provided at retailer location;
receiving a plurality of discount notifications, authorizations, reports and discounts;
close out of a plurality of discount communication sessions and data links; and
continuation of and completion of a plurality of purchasing processes having received authorization & discount amounts to be deducted from purchasers total amount.

5. the method in claim 3, wherein a means of providing a plurality of determinations and authorizations of electronic transfer of funds to a plurality of retailer merchant bank
